(19) United States
(12) Patent Application Publication
(10) Pub. No.: US 2019/0172105 A1
(43) Pub. Date: Jun. 6, 2019

(54) DISPERSED PEER-TO-PEER VOLUMETRIC STORAGE MANAGEMENT SYSTEM

(71) Applicants: Touradj Barman, San Diego, CA (US); Arash Esmailzadeh, Pasadena, CA (US)

(72) Inventors: Touradj Barman, San Diego, CA (US); Arash Esmailzadeh, Pasadena, CA (US)

(21) Appl. No.: 16/209,618

(22) Filed: Dec. 4, 2018

Related U.S. Application Data
(60) Provisional application No. 62/594,541, filed on Dec. 4, 2017.

(51) Int. Cl. G06Q 30/02; H04L 29/08

(52) U.S. Cl. CPC G06Q 30/0283; H04L 67/104; H04L 67/1097

(57) ABSTRACT

Systems and methods related to a dispersed peer-to-peer volumetric storage management system are disclosed. In some embodiments, a computer-implemented method a comprises: receiving at the computer system a set of storage requirements from a user system, the set of storage requirements including at least: a physical storage property, a geographical location, and a date range; identifying a set of candidate storage locations existing within or proximate to the geographical location, having availability during the date range, and providing storage for items having the physical storage property; calculating a storage location price for each of the candidate storage locations based on a listed price for each of the candidate storage locations adjusted by the physical storage property; and providing the set of the candidate storage locations and a corresponding storage price for each candidate storage locations of the set of candidate storage locations to the user via the user system.

### SUMMARY

Some embodiments include a dispersed peer-to-peer volumetric storage management system comprising: a communication interface; memory; and a computer processor communicatively coupled with the communication interface and the memory. In some embodiments, the computer processor is configured to: receive a set of storage requirements from a user system an API or an AI system or another system via the communication interface, the set of storage requirements including at least: a physical storage property, a geographical location, and a date range; identify a set of candidate storage locations existing within or proximate to the geographical location, having availability during the date range, and providing storage for items having the physical storage property; calculate a storage location price for each of the candidate storage locations based on a listed price for each of the candidate storage locations adjusted by the physical storage property; and provide the set of the candidate storage locations and the corresponding storage price for each candidate storage locations of the set of candidate storage locations to the user via the communication interface.

Some embodiments include a method comprising receiving at the computer system a set of storage requirements from a user system, the set of storage requirements including at least: a physical storage property, a geographical location, and a date range; identifying by the computer system a set of candidate storage locations existing within or proximate to the geographical location, having availability during the date range, and providing storage for items having the physical storage property; calculating a storage location price for each of the candidate storage locations based on a listed price for each of the candidate storage locations adjusted by the physical storage property; and providing the set of the candidate storage locations and a corresponding storage price for each candidate storage locations of the set of candidate storage locations to the user via the user system.

In some embodiments, calculating a storage location price for each of the candidate storage locations comprises determining an adjusted price for storage location price for each of the candidate storage locations using the following equation: Adj Price=β·χ·price, where β is a supply and demand factor, χ is a factor representing a percentage of the available storage volume required to accommodate one or more items based on the physical storage property, and the price is a listed price of the candidate storage location.

In some embodiments, calculating a storage location price for each of the candidate storage locations comprises determining an adjusted price for storage location price for each of the candidate storage locations using the following equation: Adj Price=β·χ·ψ·price, where β is a supply and demand factor, χ is a factor representing a percentage of the available storage volume required to accommodate one or more items based on the physical storage property, ψ is a factor based on the weight of the one or more items based on the physical storage property, and the price is a listed price of the candidate storage location.

In some embodiments, the set of storage requirements includes an upgrade factor comprising at least one or more requirements selected from the group consisting of: security requirements, visit requirements, environmental requirements, video monitoring requirements, and data collection requirements.

In some embodiments, calculating a storage location price for each of the candidate storage locations comprises determining an adjusted price for storage location price for each of the candidate storage locations using the following equation: Adj Price=β·χ·ψ·ξ·price, where β is a supply and demand factor, χ is a factor representing a percentage of the available storage volume required to accommodate one or more items based on the physical storage property, ψ is a factor based on the weight of the one or more items based on the physical storage property, ξ is an upgrade factor based on the required upgrades, and the price is a listed price of the candidate storage location.

In some embodiments, the physical storage property comprises at least one property selected from the list consisting of: weight, height, width, depth, and volume.

In some embodiments, the physical storage property comprises a requested volume; and identifying by the computer system a set of candidate storage locations existing within or proximate to the geographical location, having availability during the date range, and providing storage for items having the physical storage property further comprises identifying a candidate storage locations having an available volume that is greater than the requested volume.

In some embodiments, the physical storage property comprises a requested weight; and identifying by the computer system a set of candidate storage locations existing within or proximate to the geographical location, having availability during the date range, and providing storage for items having the physical storage property further comprises identifying a candidate storage locations having a maximum storage weight that is less than the requested weight.

Some embodiments include a trackable storage device comprising: an attachment mechanism configure to attach the trackable storage device to a storage item; a housing coupled with the attachment mechanism; a communication interface disposed within the housing; an acceleration sensor disposed within the housing; and processing logic disposed within the housing and being coupled with the acceleration sensor and/or the communication interface, the processing logic is configured to transmit a signal to a remote computer system via the communication interface in the event an acceleration signal recorded by the acceleration sensor is greater than a threshold acceleration value.

In some embodiments, the trackable storage device includes a GPS sensor, and wherein the processing logic is configured to transmit GPS data to the remote computer system via the communication interface.

In some embodiments, the trackable storage device includes a battery power sensor, and wherein the processing logic is configured to transmit battery power data to the remote computer system via the communication interface.

In some embodiments, the trackable storage device includes an attachment sensor configured to determine whether the trackable storage device is attached with a storage item, and wherein the processing logic is configured to transmit attachment data to the remote computer system via the communication interface. In some embodiments, the attachment sensor may include an environmental sensor that records, for example, light, temperature, humidity, etc.

### BRIEF DESCRIPTION OF THE FIGURES

These and other features, aspects, and advantages of the present disclosure are better understood when the following Disclosure is read with reference to the accompanying drawings.

FIG. 1 is an illustration of rentable storage volume according to some embodiments.

FIG. 2 shows a configuration of rentable storage volumes with a number of potential rentable storage volumes within the rentable storage volume according to some embodiments.

FIG. 3 is a block diagram of an online storage system according to some embodiments

FIG. 4 is a flowchart of a process for matching a renter's storage needs with available rentable storage volumes according to some embodiments.

FIG. 5 is a drawing of a storage lock box according to some embodiments.

FIG. 6 is a block diagram of the box sensor according to some embodiments.

FIG. 7 shows an illustrative computational system for performing functionality to facilitate implementation of embodiments described in this disclosure.

### DETAILED DESCRIPTION

Systems and methods are disclosed to provide an online storage marketplace. Some hosts with available rentable storage volumes within their home, property or elsewhere can provide details about available rentable storage volume via a user interface to an online database. Other renters may be interested in renting rentable storage volume. Rentable storage volume can include any three-dimensional space or portion or grouping thereof. These potential renters may search an online database for rentable storage volume that fits any number of requirements. The online database may be configured to automatically adjust the size and/or availability of the rentable storage volume in response to a host renting or providing intention, availability or showing other interest to rent one or more rentable storage volumes, combinations or fractions thereof.

As used throughout this disclosure, the term “host” is an individual, entity or group that provides rentable storage volume availability to others. The term “renter” is an individual that rents all or a portion of a rentable storage volume from one or more hosts.

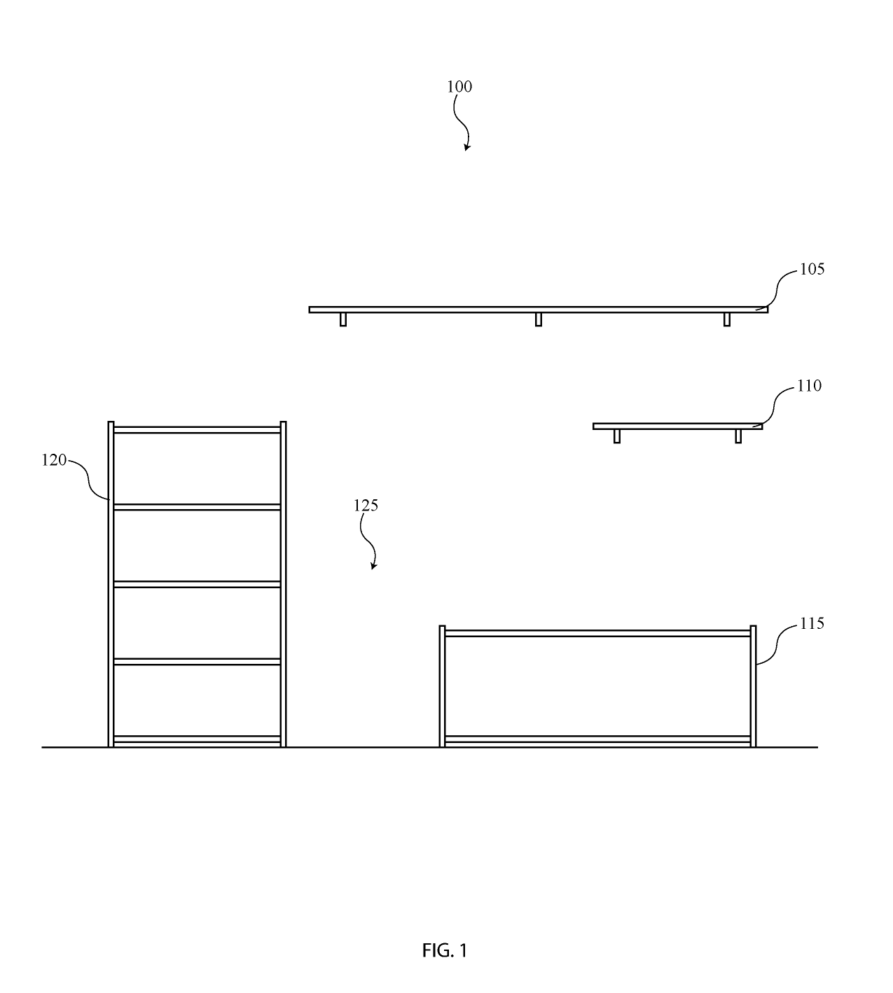

FIG. 1 is an illustration of storage location 100 used in a dispersed peer-to-peer volumetric storage management system according to some embodiments. The storage location may, for example, be a garage, storage unit, basement, bedroom, closet, locker, spare room, or any other volume, etc. The volume may be located at a commercial, residential, industrial or any other space, including virtual space. In this example, the storage location 100 may include a plurality of rentable storage volume such as, for example, a long wall shelf 105, a short wall shelf 110, a short storage shelf 115, a tall storage shelf 120, and/or a floor space 125. A rentable storage volume may include any number of rental storage volumes such as, for example, floor space, shelf space, closet space, room or garage space, etc. In some embodiments, each of the rentable storage volumes may include a volume (or specified three dimensions) that may be devisable into a plurality of divided rentable storage volumes. A renter may rent all or a portion of the rentable storage volume.

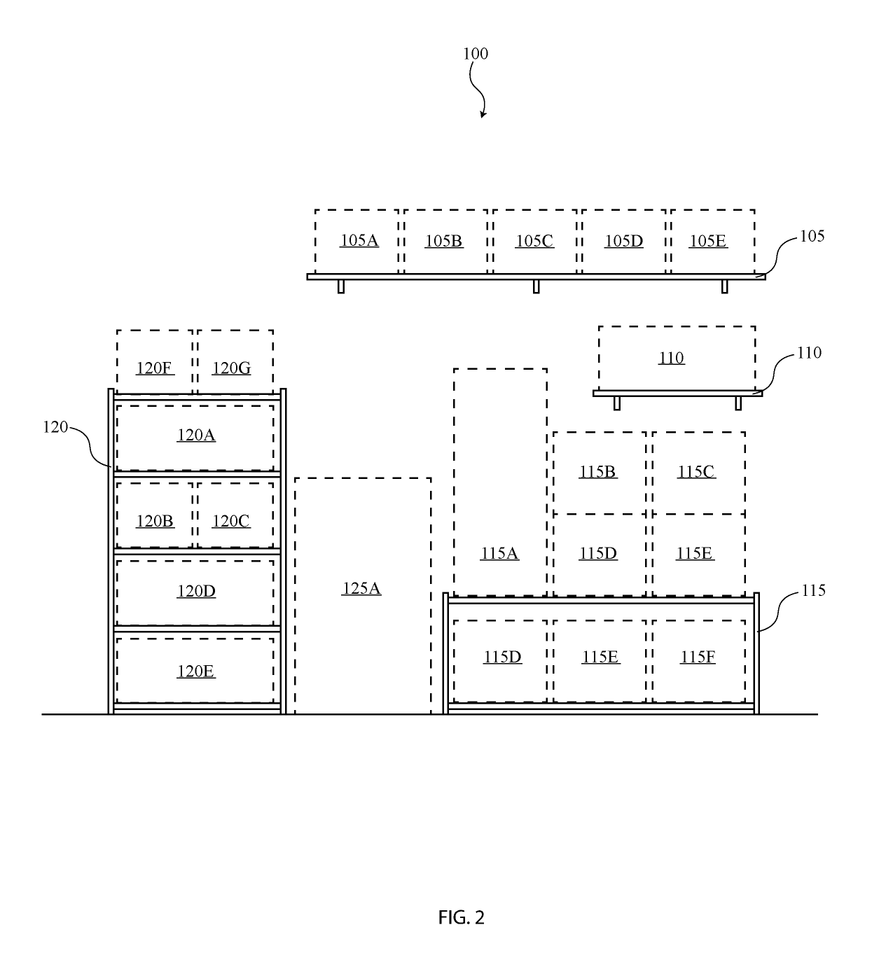

FIG. 2 shows a configuration of rentable storage volumes with a number of potential rentable storage volumes within the storage location 100 according to some embodiments. In this example, the long wall shelf 105 has five rentable storage volumes 105A, 105B, 105C, 105D, and 105E. In this example, the short wall shelf 110 has a single rentable storage volume 110A. The various rentable storage volumes may or may not have the same dimensions. Storage volumes may be divided and/or combined to create infinite configurations of variable storage volumes, any singular or combination of which may be rentable.

In this example, the short storage shelf 115 has a bottom shelf with three rentable storage volumes 115D, 115E, and 115F. The short storage shelf 115 has a top shelf with a number of rentable storage volumes 105A, 115B, 115C, 115D, and 115E. The rentable storage volume 115A may accommodate large items. Rentable storage volumes 115B, 115C, 115D, and 115E may be stackable rentable storage volumes where various items or boxes may be stacked on upon another.

In this example, the tall storage shelf 120 has five shelves with rentable storage volumes 120A, 120B, 120C, 120D, 120E, 120F, and 120G.

In this example, the floor space 125 may provide a large (and/or tall) rentable storage volume 125A.

The size, shape, dimension, weight limitations, configuration and/or any other one or more aspects of the various rentable storage volumes (e.g., physical storage property) may be divisible, configurable, or adjustable.

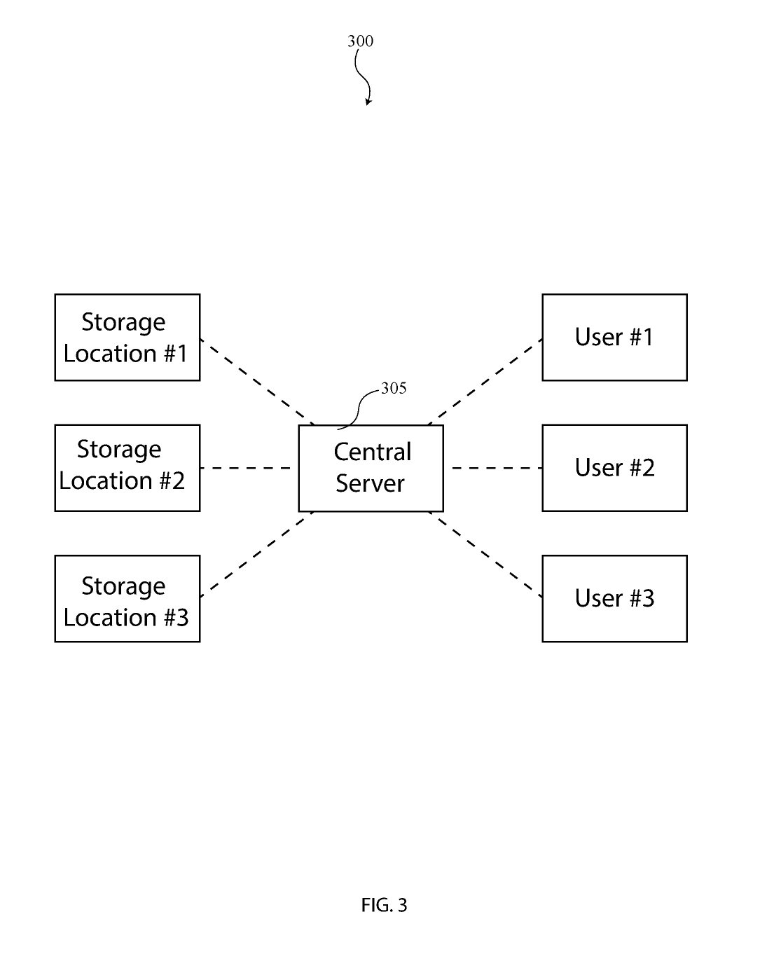

FIG. 3 is a block diagram of a dispersed peer-to-peer volumetric storage management system 300 according to some embodiments. The online storage system 300 may include, for example, a central server 305. The server 305 may include a plurality of servers that may be geographically localized or geographically distributed. The central server 305 may include one or more or all of the components of the computational system 700. The online storage system 300 may be in communication with one or more hosts that are offering rentable storage volume (e.g., rentable storage volume #1, rentable storage volume #2, rentable storage volume #3, etc.), and/or one or more renters that are in need of rentable storage volume (e.g., renter #1, renter #2, renter #3, etc.) for storing one or more items.

Each rentable storage volume may have one or more parameters associated with it in an online database. The online database, for example, may be stored in the central server 305. These parameters may include various details about the rentable storage volume such as, for example, the physical location, address, city, or zip code of the rentable storage volume; the dimensions of the rentable storage volume, the weight limit of the rentable storage volume; its access availability, any information about the host, environmental conditions, sensor and/or related data availability, monitoring information; etc. The parameters may also, for example, include whether the rentable storage volume is video monitored and/or environmentally monitored and/or controlled (e.g., temperature, humidity, air quality, non-smoking, etc.). The parameters, for example, may also include whether current and/or historical data about the environmental parameters are available, and if so, provide that data. Certain remote controls of the storage volume may be present, for example the ability for a renter to remotely, for example via a computer system or app, control environmental conditions, e.g. adjust the thermostat to control the temperature in the volume, etc. The parameters may include information about what remote control a host may have over the storage volume such as changing the temperature, the lighting, the humidity, playing music, activating and controlling the focus of a camera or microphone, etc. The host may also be able to broadcast audio or video, live or recorded from any source into the volume. The host may also be able to control actions within the volume, for example direct a robot or other electro-mechanical entity or system to perform actions within the volume, e.g. control a robot that moves an item from one location within the volume to another. Parameters may include any level of detail of any such capability available to a renter. The parameters, for example, may also include whether the rentable storage volume requires and/or allows whether other storage items may be stacked on top of or under another stored item, whether chemicals are or are allowed to be stored in a nearby rentable storage volume, the weight load of the rentable storage volume, the type and/or brand of shelving in the rentable storage volume, etc. Any attribute may be measured, stored, and/or made available as an output for access, viewing, or input into another system, calculation, remote manipulation or consideration, analysis, readout, or action of any type. As another example, the parameters may specify when the owner of a stored item or volume (a “renter”) may access the rentable storage volume and/or items contained within in such volume(s), such as, for example, the times of day the renter can access the stored items in the rentable storage volume. The parameters may also include the address and/or zip code of the rentable storage volume. The parameters may also include whether smoking is permitted near the rentable storage volume. The parameters may also include the number of flights of stairs up or down that may need to be traversed to reach the rentable storage volume. The parameters may include GPS and/or elevation of the rentable volume. The parameters may include any data that can be derived from other parameters, e.g. GPS data may allow demographic data of the location to be obtained and provided. The parameters may also include additional security information such as, for example, security guard, fenced, locks, number of people with access, etc. of the rentable storage volume. Historical and/or current security data or data of any other attribute or kind may be available. Historical parameter information may be available. The parameters may also include the duration the rentable storage volume may be available for storage. Various other parameters may be included, such as, for example, address, volume, ratings, reviews, environmental factors, cost, etc. These perimeters may pertain to the volume itself, the environment housing the volume, the host, or anything else, etc.

| | | | Max | Max | Max | | | | | |
|---|---|---|---|---|---|---|---|---|---|---|
| P2P | | | Width | Height | Length | Max | Video | Temp. | | |
| Facility | Owner | Location | (in) | (in) | (in) | Weight | Monitor | Control | Stacked | Access |
| 1 | Jane Doe | Garage | 60 | 480 | 60 | 50 | Yes | No | No | 9 AM-9 PM |
| 2 | Jane Doe | Garage | 60 | 480 | 60 | 50 | Yes | No | No | 9 AM-9 PM |
| 3 | Jane Doe | Garage | 60 | 480 | 60 | 150 | Yes | No | No | 9 AM-9 PM |
| 4 | John Doe | Basement | 24 | 24 | 36 | 100 | Yes | Yes | Yes | Appt. |
| 5 | John Doe | Basement | 24 | 24 | 36 | 100 | Yes | Yes | Yes | Appt. |
| 6 | Jeb Doe | Storage Unit | 24 | 24 | 36 | 100 | No | No | Yes | All day |
| 7 | Jeb Doe | Storage Unit | 24 | 24 | 36 | 50 | No | No | Yes | All day |
| 8 | Jeb Doe | Storage Unit | 24 | 24 | 36 | 25 | No | No | Yes | All day |

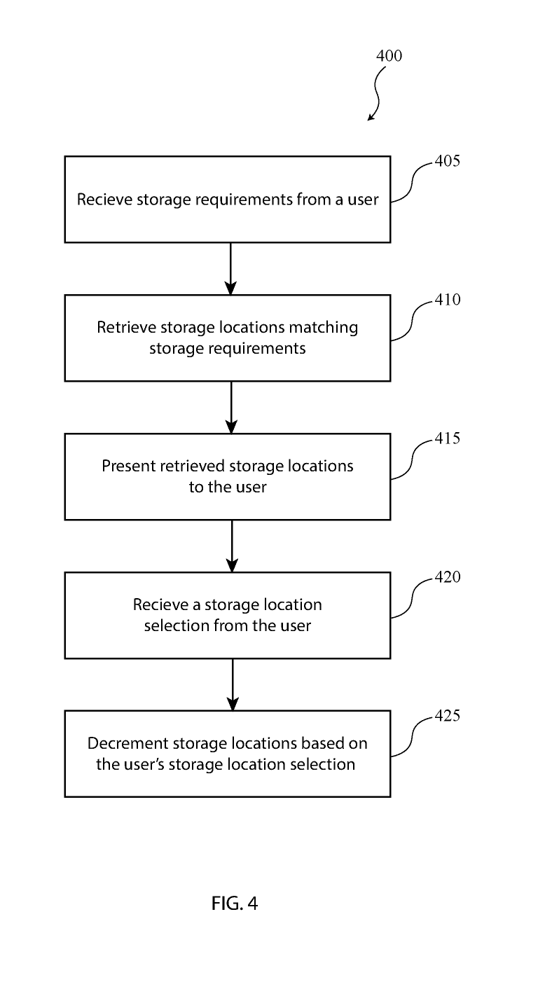

FIG. 4 is a flowchart of a process 400 for matching renter storage needs with available rentable storage volumes according to some embodiments. Process 400 begins at block 405. At block 405, rental storage requirements or needs may be received from a renter or potential renter. For example, the storage requirements may be received at central server 305 (or a plurality of servers assembled in any configuration) from a renter using a computer, laptop, smartphone, tablet, or other computing device, such as an TOT device, which may be able to provide some data, attributes or requirements automatically.

At block 410 available rentable storage volumes matching the storage requirements received from the renter may be retrieved from a rentable storage volume database (e.g., similar to the chart shown above). These available rentable storage volumes, for example, may not be exact matches of the parameters entered by the renter, but may be close to the parameters. For example, the renter may enter a zip code, and the returned available rentable storage volumes may be locations having zip codes in the surrounding area or adjacent to the entered zip code.

At block 415 information about the retrieved available rentable storage volumes may be presented to the renter. For example, photographs of the rentable storage volumes, the parameters associated with the rentable storage volume, etc. may be presented to the renter. Examples of what may be stored may be presented to the renter or potential renter. In some embodiments, this information may be sorted based on price, location, relevance, or any other parameter.

In some embodiments, at block 415 a price may be presented to the renter. The price, for example, may be a function of the amount of space being used. For example, the price may be a function of the unit volume of being rented. For example, if the renter desires to store an item with dimensions half the size of the rentable storage volume, the renter may be charged either half the price of the total price of the rentable storage volume or the total price depending on the available rentable storage volume and/or by the location owner preferences. In some embodiments, the price of storing an item may be a ratio of the total price proportional to the ratio of the available storage volume and the rented storage volume.

In some embodiments, prices may be adjusted based on supply and demand in a specific area.

Adj Price=β·χ·ψ·ξ·price.

For example, β may be a factor based on the supply and demand, for example, the supply and demand of rentable storage volumes in the area. For example,

$$β = \frac{demand}{supply} .$$

For example, χ may be a factor based on the percentage of the rentable storage volumes. For example, χ may be increments of quarters of a full rentable storage volume. For example,

$$χ = \frac{n}{4} ,$$

where n=1, 2, 3, 4. As another example, χ may be a factor based on the weight of the item. For example, if a storage shelf (e.g., shelf 105) may hold 100 pounds of weight, and a single storage item weighs 100 pounds, then the single storage item will be the only item stored on the storage shelf. For example, assuming the storage space has a weight limit, l, the storage item has a weight, w, and n storage spaces, then if

$$w > \frac{l}{n} then ψ = n \frac{l}{w} .$$

As another example, ξ may represent a price increase or decrease based on additional factors required by the renter such as, for example, security requirements, visit requirements, video monitoring requirements, environmental requirements, data collection requirements, etc.

The price may adjust in any fashion programmatically.

A renter or potential renter may have more specific volumetric renting needs than are available in one location where volumetric storage is available. In this case, the system can calculate, recommend, etc. combinations of volume available for rent that can meet the renter or potential renter's total volumetric rental needs. These calculations may take into consideration any attribute or parameter(s) of the volumetric rental needs and match them according to best fit per any algorithm.

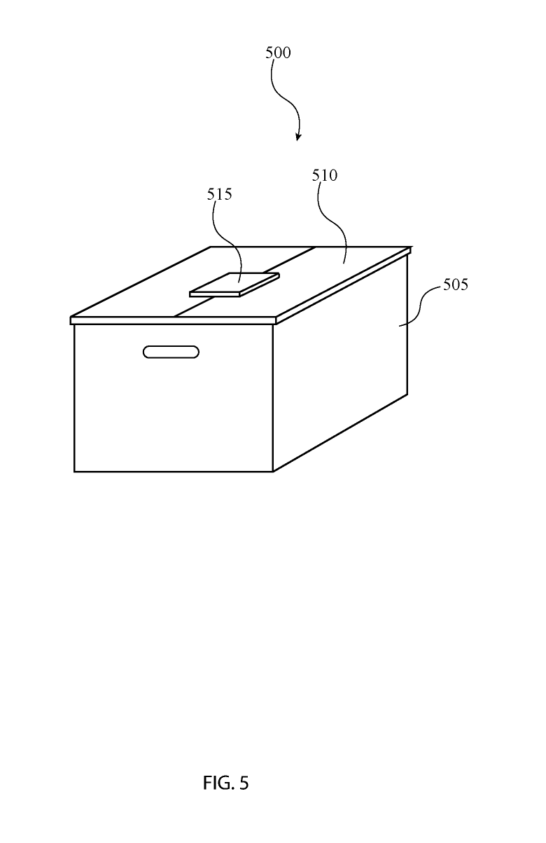

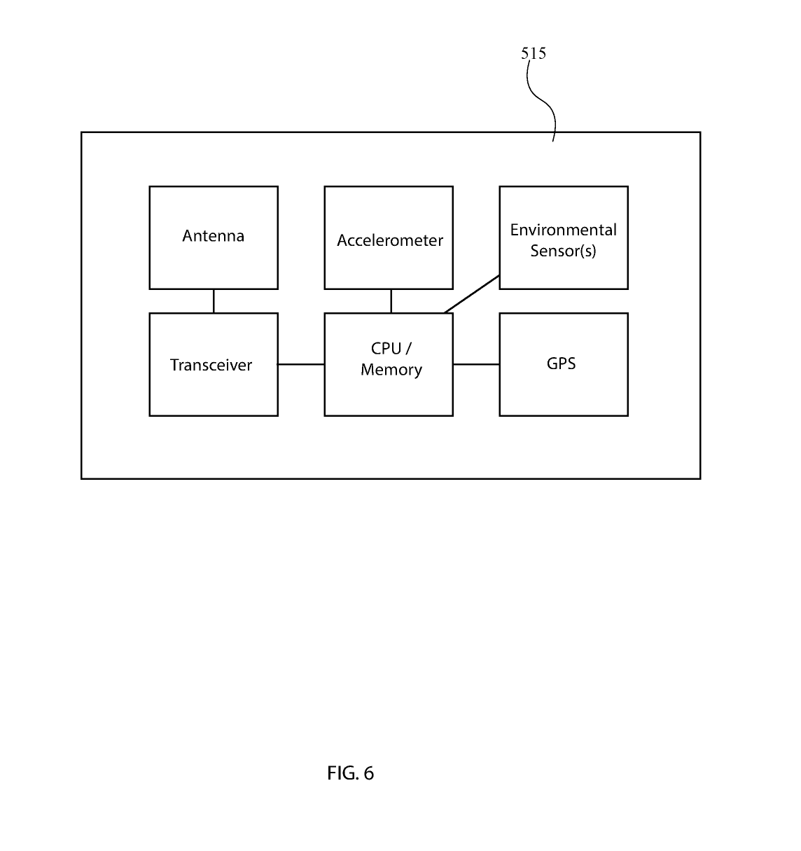

Internet of Things (IoT) sensors or other types may be affixed to environments or objects in or containing volumetric storage such as, for example, as shown in FIG. 5 and/or FIG. 6. These sensors may provide any variety of data to the system. This data may be used as one or more inputs to produce any output of the system. Sensors elsewhere may provide input that may assist in determination and/or matching of volumetric storage needs. Sensors may be available to adjust environmental conditions or parameters based on pre-programmed actions. For example, a sensor may turn on air conditioning if it detects the temperature is above a threshold.

Virtual Reality systems and/or Augmented Reality may be employed by a host to allow renters, potential renters, hosts of volumetric space for rent, and others to visualize current or potential configurations of items or containers of items demanding volumetric storage in potentially or actually rented volumes. These may also be employed if the volumetric space is virtual.

As another example, the price for an available rentable storage volume may depend on the stackability of the items being stored. If the available rentable storage volume can hold 3 boxes stacked one on top of the other, and the renter only wants to place a single item but does not want to stack the item or have other items stacked upon it, the price may be determined to be the full price of the location or volume. If the renter is willing to stack the item then the price may be one third of the cost of the location, or some lesser priced based on a pricing formula with that desire as one of the inputs.

For example, at block 405 may enter the following requirements:

Number of boxes: 3

Dimensions of each box: 60″×24″×24″

Stackable: Yes

Location: Outdoor

In response, at block 410, the central server may retrieve units 1, 2, and 3, and/or at block 415 present information about these units to the renter.

As another example, at block 405 may enter the following requirements:

Number of boxes: 3

Dimensions of each box: 24″×24″×24″

Stackable: Yes

Location: Indoor

In response, at block 410, the central server may return units 4 and 5, and/or at block 415 present information about these units to the renter.

As another example, at block 405 may enter the following requirements:

Number of boxes: 3

Dimensions of each box: 24″×24″×24″

Stackable: Yes

Location: any

Video Monitoring: Yes

In response, at block 410, the central server (e.g., server 305) may retrieve units 1, 2, 3, 4, and 5, and/or at block 415 present information about these units to the renter.

At block 420 a rentable storage volume selection can be received from the renter. For instance, one of the various rentable storage volumes presented to the renter in block 415 may be selected by the renter via an application, web interface or other computational device or system.

At block 425 the available rentable storage volume may be decremented from the database of rentable storage volumes. In some embodiments, an available rentable storage volume may be removed from the database. In some embodiments, the dimensions of an available rental storage location may be changed to reflect the addition to the available rentable storage volume. For example, if the storage requirement dimensions received from the renter in block 405 are 30″×120″×30″, and the renter selects rentable storage volume #3 in the example table shown in this disclosure, which has available dimensions of 60″×480″×60″. In this example, the available rentable storage volume may be decremented by subtracting the size of the renter's rentable storage volume dimensions from the available rentable storage volume dimensions. In this example, the available rentable storage volume dimensions may be decremented to 30″×360″×30″.

In some embodiments, the rentable storage volume dimensions may be decremented an additional amount to ensure sufficient tolerances between stored items in the rentable storage volumes such as, for example, an additional 2″. For example, the available rentable storage volume may be decremented to 28″×358″×28″.

In some embodiments, the available weight load of the available rentable storage volume may also be decremented. For example, if the weight of the renter's stored item is 50 lbs., the available stored weight may be decremented to 100 lbs.

In some embodiments, certain stored items may alter environmental conditions, for example textiles stored may reduce sound in the volume or make the volume more prone to fire. The quantity of stored items may affect conditions as well, for example a small rug may not change the environment as much as several rugs. The presence of certain items may adjust parameters which may be made available to a renter or potential renter. These changes may affect how another renter or potential renter decides to use the volume, including whether they want to use it or not.

FIG. 5 is a drawing of a storage lock box 500 according to some embodiments. The storage lock box 500 includes a box body 505 and a closeable lid 510. The lid, for example, may include box sensor 515 that may be attached to the storage lock box 500. The box sensor 515 may be attached to any portion of the lock box 500. The box sensor 515 may be able to detect and/or record motion data, the location data, environmental data, attachment data, and/or any other attributes or inputs related to the storage lock box 500. In some embodiments, the sensor 515 may be attached to the storage lock box 500 with double stick tape or other adhesive, a band, or by affixing or joining methods that may or may not be integrated into the box. While the box sensor 515 is shown on the lid, the box sensor may be coupled anywhere on and/or in the box in any way. A remote sensor may be able to detect details about the box, as well. For example, a remote infrared, laser, or sensor may be able to determine the temperature of a box even though it is not affixed to or touching the box.

In some embodiments, the storage location may include any number of sensors such as, for example, environmental sensors, video sensors, intrusion sensors, etc. These storage location sensors may log data, communicate data, sound alarms, and/or provide input into any calculation, storage, system or other output production.

In the example shown in FIG. 5, the box sensor 515 is detachably coupled with the closeable lid 510 such that the storage lock box 500 may only be opened if the box sensor 515 is first removed.

As another example, the box sensor 515 may be coupled with a flexible or expandable band that may be wrapped around the storage lock box 500. The flexible band of the box sensor 515 may wrapped around the storage lock box 500 such that the box sensor 515 must be removed prior to opening the storage lock box 500. In some embodiments, the flexible or expandable band may be adjustable so that a flexible or expandable band can fit around various sized boxes. In some embodiments, the box sensor 515 may be coupled with the flexible or expandable band and may be able to determine if the flexible or expandable band has been cut and/or removed from the box.

In some embodiments, the box sensor 515 may include a sensor that can determine whether the box sensor 515 is coupled with the lock box 500. For example, the box sensor 515 may include capacitive sensor that senses the capacitance of the box. If the box sensor 515 is removed from the box, the capacitance measured by the capacitive sensor would change signaling that the box sensor 515 has been removed. As another example, the box sensor 515 may be coupled with the flexible or expandable band. The flexible or expandable band may include a conductor that runs through the flexible or expandable band. The box sensor 515 may measure the resistance or current flow or voltage across the conductor and may determine whether the flexible or expandable band has been cut by measuring changes in the resistance, current, and/or voltage through the conductor.

In some embodiments, the box sensor 515 may include any number of sensors.

FIG. 6 is a block diagram of the box sensor 515 according to some embodiments. The box sensor 515 may include a processor and/or memory, a transceiver, and/or antenna. The transceiver may include any or all components of computational system 700. The transceiver and/or antenna may be configured to communicate data, for example, data stored in the memory, via Bluetooth, 3G, 4G, 5G, LTE, Wi-Fi, variants thereof, and/or any other wireless and/or wired communication protocol. Any commercially or otherwise available hardware, sensor, software, algorithm or technology, in any quantity or configuration, may be integrated to provide and/or record data, perform or control functions, or perform or maintain any other role in the system.

The box sensor 515 may also include an accelerometer. In some embodiments, the box sensor 515 may periodically, or at any other type of interval, read acceleration data from the accelerometer. When absolute acceleration data is greater than a given threshold consistent with moving the box sensor 515, the acceleration data may be written into the memory for a predetermined period of time. The converse may also be true. In some embodiments, the acceleration data may be communicated wireless via the transceiver and/or antenna or any other mechanism or system.

Thresholds may be stored for any attribute and/or parameter such that notifications may be generated, stored, and/or sent based on thresholds being met, surpassed, or not for any duration.

The box sensor 515 may also include a GPS or other location sensor and/or system able to determine or suggest an indoor or outdoor location and/or altitude with some degree of accuracy. Positioning data from one or more of these sources may be periodically recorded in memory and/or transmitted to a central server via the transceiver and/or the memory.

The box sensor 515 may also include one or more environmental sensors such as, for example, a thermometer, humidity sensor, air quality sensor, chemical sensor, etc. Environment data from the one or more environmental sensors may be periodically recorded in memory and/or transmitted to a central server via the transceiver and/or the memory.

The box sensor 515 may also include one or more batteries or systems to receive power via wired and/or wireless and/or inertial and/or other internal and/or external means that can provide power to the various components of the box sensor 515. Any type of power source may be used by box sensor 515. Any type of communication technology may be used by box sensor 515.

Data from the box sensor 515 may be transmitted to the central server 303 directly or via any intermediary system, device, network or set thereof. That data may be retrieved by a host and/or a renter.

For example, data from the box sensor 515 may be used to indicate to a renter and/or a host that a storage lock box has been moved (e.g., via an accelerometer signal that is greater than a threshold value) and/or is subject to given environmental conditions (e.g., via a thermometer signal that is greater than a threshold value). This data may be accessible by a renter, a host, system administrator, a designee of any of the above, etc. Some renters may, for example, request that an item in storage not be moved when in storage, and/or may only be subject to specific environmental conditions. Data from the box sensor 515, for example, may be used to detect violations of this preference by comparing data from a sensor against a threshold value. In some embodiments, sensor data may be averaged over a period of time and data from the average value may be compared with a threshold value. Data from the box sensor 515, for example, may be used to alert a renter that their box has been moved and/or subjected to a given environmental condition. In some embodiments, the renter may be alerted via a wireless signal transmitted from the transceiver, antenna and/or related device.

Fee reductions may be established and stored as parameters. Fee reductions may become available when one or more parameters pass established and/or agreed upon thresholds. The system can track these and manipulate them in all forms.

In some embodiments, box sensor 515 may be in a sleep mode until data from a sensor (or an average data value) is greater than a threshold value. In sleep mode, for example, the antenna and/or transceiver may be turned off. As another example, the processor may be processing at a slower rate in sleep mode. As another example, data sampling from one of the sensors may occur between longer periods. Once awake, box sensor 515 may record sensor data more frequently and/or transmit sensor data. Any type of sensor or sensor data or anything else may be used to awaken the system.

In some embodiments, the box sensor 515 may include a battery power sensor that may sense battery power and/or communicate a signal with a remote computer when the battery power is below a threshold. In some embodiments, the box sensor 515 may include a photoelectric array that may be used to charge a battery. Various other non-contact charing methos may be employed.

In some embodiments, a video camera may be placed near the rentable storage volume and may record the stored item within the rentable storage volume. In some embodiments, renters with stored items may be provided with a video stream of the rentable storage volume. In some embodiments, when a renter is no longer using the rentable storage volume access to the video stream may be discontinued. In some embodiments, a video stream may be provided via a computer interface that allows the renter to outline an item to watch within the video frame. The central server may identify the pixels defining the boundary of the stored item based on the renter input and/or may determine if the stored item is moved by determining if the pixels outlining the stored item have moved more than a threshold value within the video frame.

Different prices may be charged for access to different data, quality of data, frequency of data, etc. Prices may vary based on attribute, parameter or anything else, manually, automatically or otherwise.

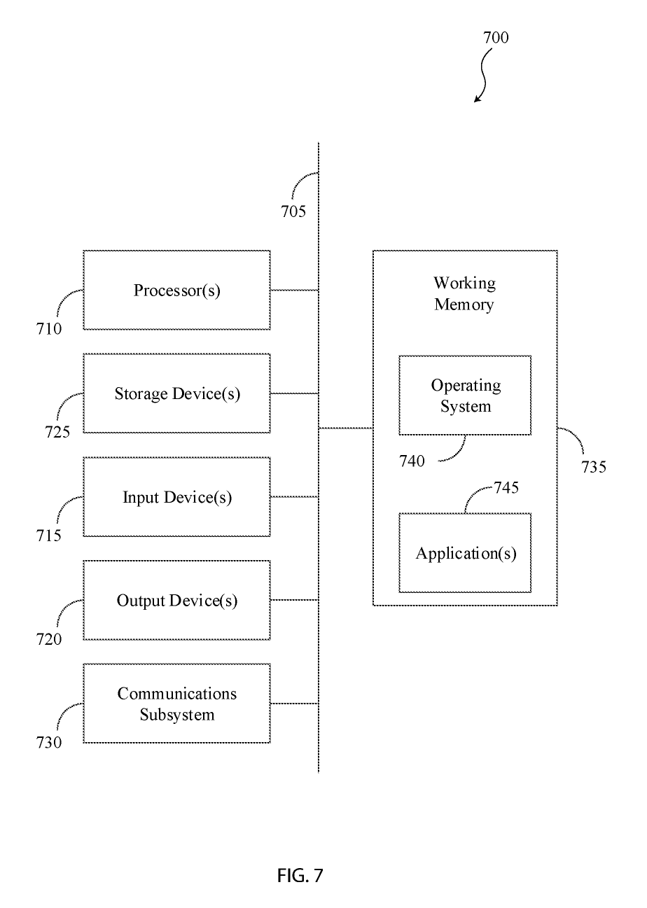

The computational system 700, shown in FIG. 7 can be used to perform any of the embodiments of the invention. For example, computational system 700 can be used to execute methods 400 or any other process or method described in this disclosure. As another example, computational system 700 can be used perform any calculation, identification and/or determination described here. Computational system 700 includes hardware elements that can be electrically coupled via a bus 705 (or may otherwise be in communication, as appropriate). The hardware elements can include one or more processors 710, including without limitation one or more general-purpose processors and/or one or more special-purpose processors (such as digital signal processing chips, graphics acceleration chips, and/or the like); one or more input devices 715, which can include without limitation a mouse, a keyboard and/or the like; and one or more output devices 720, which can include without limitation a display device, a printer and/or the like. In some embodiments, the computational system 700 may include or be coupled with a home automation device such as, for example, Alexa, Siri, Google Home, etc. In some embodiments, the computational system 700 may be connected from a remote system via APIs and/or other interfaces.

The computational system 700 may further include (and/or be in communication with) one or more storage devices 725, which can include, without limitation, local and/or network accessible storage and/or can include, without limitation, a disk drive, a drive array, an optical storage device, a solid-state storage device, such as a random-access memory (“RAM”) and/or a read-only memory (“ROM”), which can be programmable, flash-updateable and/or the like. The computational system 700 might also include a communications subsystem 730, which can include without limitation a modem, a network card (wireless or wired), an infrared communication device, a wireless communication device and/or chipset (such as a Bluetooth device, an 802.6 device, a Wi-Fi device, a WiMAX device, cellular communication facilities, etc.), and/or the like. The communications subsystem 730 may permit data to be exchanged with a network (such as the network described below, to name one example), and/or any other devices described herein. In many embodiments, the computational system 700 will further include a working memory 735, which can include a RAM or ROM device, as described above.

The computational system 700 also can include software elements, shown as being currently located within the working memory 735, including an operating system 740 and/or other code, such as one or more application programs 745, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 725 described above.

In some cases, the storage medium might be incorporated within the computational system 700 or in communication with the computational system 700. In other embodiments, the storage medium might be separate from a computational system 700 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 700 and/or might take the form of source and/or installable code, which, upon compilation and/or installation on the computational system 700 (e.g., using any of a variety of generally available compilers, installation programs, compression/decompression utilities, etc.) then takes the form of executable code.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. A dispersed peer-to-peer volumetric storage management system comprising:
a communication interface;
a memory; and
a computer processor communicatively coupled with the communication interface and the memory, the computer processor configured to:
receive a set of storage requirements from a user system via the communication interface, the set of storage requirements including at least: a physical storage property, a geographical location, and a date range;
identify a set of candidate storage locations existing within or proximate to the geographical location, having availability during the date range, and providing storage for items having the physical storage property; and
provide the set of the candidate storage locations and the corresponding storage price for each candidate storage locations of the set of candidate storage locations to the user via the communication interface.

2. The dispersed peer-to-peer volumetric storage management system according to claim 1, wherein the computer process is further configured to calculate a storage location price for each of the candidate storage locations based on a listed price for each of the candidate storage locations adjusted by the physical storage property.

3. The dispersed peer-to-peer volumetric storage management system according to claim 1, wherein calculating a storage location price for each of the candidate storage locations comprises determining an adjusted price for storage location price for each of the candidate storage locations using the following equation: Adj Price=β·χ·price, where β is a supply and demand factor, χ is a factor representing a percentage of the available storage volume required to accommodate one or more items based on the physical storage property, and the price is a listed price of the candidate storage location.

4. The dispersed peer-to-peer volumetric storage management system according to claim 1, wherein calculating a storage location price for each of the candidate storage locations comprises determining an adjusted price for storage location price for each of the candidate storage locations using the following equation: Adj Price=β·χ·ψ·price, where β is a supply and demand factor, χ is a factor representing a percentage of the available storage volume required to accommodate one or more items based on the physical storage property, ψ is a factor based on the weight of the one or more items based on the physical storage property, and the price is a listed price of the candidate storage location.

5. The dispersed peer-to-peer volumetric storage management system according to claim 1, wherein the set of storage requirements includes an upgrade factor comprising at least one or more requirements selected from the group consisting of: security requirements, visit requirements, environmental requirements, video monitoring requirements, and data collection requirements.

6. The dispersed peer-to-peer volumetric storage management system according to claim 5, wherein calculating a storage location price for each of the candidate storage locations comprises determining an adjusted price for storage location price for each of the candidate storage locations using the following equation: Adj Price=β·χ·ψ·ξ·price, where β is a supply and demand factor, χ is a factor representing a percentage of the available storage volume required to accommodate one or more items based on the physical storage property, ψ is a factor based on the weight of the one or more items based on the physical storage property, ξ is an upgrade factor based on the required upgrades, and the price is a listed price of the candidate storage location.

7. The dispersed peer-to-peer volumetric storage management system according to claim 1, wherein the physical storage property comprises at least one property selected from the list consisting of: weight, height, width, depth, and volume.

8. The dispersed peer-to-peer volumetric storage management system according to claim 1,
wherein the physical storage property comprises a requested volume; and
wherein identifying by the computer system a set of candidate storage locations existing within or proximate to the geographical location, having availability during the date range, and providing storage for items having the physical storage property further comprises identifying a candidate storage locations having an available volume that is greater than the requested volume.

9. The dispersed peer-to-peer volumetric storage management system according to claim 1,
wherein the physical storage property comprises a requested weight; and
wherein identifying by the computer system a set of candidate storage locations existing within or proximate to the geographical location, having availability during the date range, and providing storage for items having the physical storage property further comprises identifying a candidate storage locations having a maximum storage weight that is less than the requested weight.

10. A method implemented by a computer system, the method comprising:
receiving at the computer system a set of storage requirements from a user system, the set of storage requirements including at least: a physical storage property, a geographical location, and a date range;
identifying by the computer system a set of candidate storage locations existing within or proximate to the geographical location, having availability during the date range, and providing storage for items having the physical storage property;
calculating a storage location price for each of the candidate storage locations based on a listed price for each of the candidate storage locations adjusted by the physical storage property; and
providing the set of the candidate storage locations and a corresponding storage price for each candidate storage locations of the set of candidate storage locations to the user via the user system.

11. The method according to claim 10, wherein calculating a storage location price for each of the candidate storage locations comprises determining an adjusted price for storage location price for each of the candidate storage locations using the following equation: Adj Price=β·χ·price, where β is a supply and demand factor, χ is a factor representing a percentage of the available storage volume required to accommodate one or more items based on the physical storage property, and the price is a listed price of the candidate storage location.

12. The method according to claim 10, wherein calculating a storage location price for each of the candidate storage locations comprises determining an adjusted price for storage location price for each of the candidate storage locations using the following equation: Adj Price=β·χ·ψ·price, where β is a supply and demand factor, χ is a factor representing a percentage of the available storage volume required to accommodate one or more items based on the physical storage property, ψ is a factor based on the weight of the one or more items based on the physical storage property, and the price is a listed price of the candidate storage location.

13. The method according to claim 10, wherein the set of storage requirements includes an upgrade factor comprising at least one or more requirements selected from the group consisting of: security requirements, visit requirements, environmental requirements, video monitoring requirements, and data collection requirements.

14. The method according to claim 13, wherein calculating a storage location price for each of the candidate storage locations comprises determining an adjusted price for storage location price for each of the candidate storage locations using the following equation: Adj Price=β·χ·ψ·ξ·price, where β is a supply and demand factor, χ is a factor representing a percentage of the available storage volume required to accommodate one or more items based on the physical storage property, ψ is a factor based on the weight of the one or more items based on the physical storage property, ξ is an upgrade factor based on the required upgrades, and the price is a listed price of the candidate storage location.

15. The method according to claim 10,
wherein the physical storage property comprises a requested volume; and
wherein identifying by the computer system a set of candidate storage locations existing within or proximate to the geographical location, having availability during the date range, and providing storage for items having the physical storage property further comprises identifying a candidate storage locations having an available volume that is greater than the requested volume.

16. The method according to claim 10,
wherein the physical storage property comprises a requested weight; and
wherein identifying by the computer system a set of candidate storage locations existing within or proximate to the geographical location, having availability during the date range, and providing storage for items having the physical storage property further comprises identifying a candidate storage locations having a maximum storage weight that is less than the requested weight.

17. A trackable storage device comprising:
an attachment mechanism configure to attach the trackable storage device to a storage item;
a housing coupled with the attachment mechanism;
a communication interface disposed within the housing;
an acceleration sensor disposed within the housing; and
processing logic disposed within the housing and being coupled with the acceleration sensor and/or the communication interface, the processing logic is configured to transmit a signal to a remote computer system via the communication interface in the event an acceleration signal recorded by the acceleration sensor is greater than a threshold acceleration value.

18. The trackable storage device according to claim 17, further comprising a GPS sensor, and wherein the processing logic is configured to transmit GPS data to the remote computer system via the communication interface.

19. The trackable storage device according to claim 17, further comprising a battery power sensor, and wherein the processing logic is configured to transmit battery power data to the remote computer system via the communication interface.

20. The trackable storage device according to claim 17, further comprising an attachment sensor configured to determine whether the trackable storage device is attached with a storage item, and wherein the processing logic is configured to transmit attachment data to the remote computer system via the communication interface.
